(19) United States
(12) Patent Application Publication
(10) Pub. No.: US 2013/0011748 A1
(43) Pub. Date: Jan. 10, 2013

(54) POWER SUPPLY DEVICE AND ELECTRONIC APPARATUS

(75) Inventors: Hiroki MITA, Kanagawa (JP); Takaaki NAKAGAWA, Kanagawa (JP); Tsunetoshi SAMUKAWA, Kanagawa (JP); Taiki SUGIYAMA, Kanagawa (JP); Hideki SAKAI, Kanagawa (JP)

(73) Assignee: Sony Corporation, Tokyo (JP)

(21) Appl. No.: 13/533,483

(22) Filed: Jun. 26, 2012

(30) Foreign Application Priority Data
Jul. 6, 2011 (JP) 2011-150040
Aug. 26, 2011 (JP) 2011-184509

(51) Int. Cl. H01M 8/16

(52) U.S. Cl. 429/401

(57) ABSTRACT

A power supply device in which an enzyme is immobilized as a catalyst on negative electrodes and/or positive electrodes, includes electromotive portions in which at least two of the negative electrodes and the positive electrodes are connected in series, and a fuel supply portion which communicates with the negative electrodes and which simultaneously supply a fuel to the negative electrodes, and in the power supply device, the fuel supply portion includes fuel-supply adjusting portions which adjust fuel supply to the negative electrodes.

### CROSS REFERENCES TO RELATED APPLICATIONS

The present application claims priority to Japanese Priority Patent Application JP 2011-150040 filed in the Japan Patent Office on Jul. 6, 2011, and JP 2011-184509 filed in the Japan Patent Office on Aug. 26, 2011, the entire contents of which are hereby incorporated by reference.

### BACKGROUND

The present disclosure relates to a power supply device. In more particular, the present disclosure relates to a power supply device which is able to realize an increase in output by connecting at least two electrodes in series and which can easily supply a fuel to the electrodes and to an electronic apparatus using this power supply device.

Cells can be roughly classified into chemical cells and physical cells, and as the chemical cells, for example, there may be mentioned primary cells, such as a manganese dry cell, an alkaline dry cell, a nickel-based primary cell, a lithium cell, an alkaline button cell, a silver oxide cell, and an air (zinc) cell; secondary cells, such as a nickel-cadmium cell, a nickel-hydrogen cell, a lithium-ion cell, a lead storage cell, and an alkali storage cell; and a fuel cell such as a bio-fuel cell. In addition, as the physical cells, for example, a solar cell may be mentioned.

Hereinafter, a chemical cell relating to the present disclosure will be described. The primary cell is a cell which contains a reactive material and generates a current by a chemical reaction of the reactive material and which can be used until all the reactive material is consumed, and a dry cell may be mentioned by way of example. The secondary cell is a cell which can be repeatedly used in such a way that although the amount of a reactive material contained therein is decreased when a current is generated, by charging the cell, a reverse reaction occurs, and a reaction product is allowed to return to the reactive material, and for example, a car battery and a lithium ion cell may be mentioned.

Among the cells mentioned above, since a fuel cell (hereinafter, referred to as a “bio-fuel cell”) in which a oxidoreductase is immobilized as a catalyst on at least one of a negative electrode and a positive electrode can efficiently extract electrons from a fuel, such as glucose and ethanol, which is difficult to react by a general industrial catalyst, many attention have been paid to this cell as a next-generation fuel cell having a large capacity and high safety.

As one example of the bio-fuel cell, a reaction scheme of a bio-fuel cell which uses glucose as a fuel will be described. In the bio-fuel cell which uses glucose as a fuel, an oxidation reaction of glucose progresses on a negative electrode, and a reduction reaction of oxygen (O₂) in the air progresses on a positive electrode. In addition, at a negative electrode side, electrons are transferred from glucose to the electrode (carbon) through glucose dehydrogenase, nicotinamide adenine dinucleotide (NAD+), diaphorase, and mediator in this order.

On the other hand, the bio-fuel cell as described above has a problem in that the output is low as compared to that of other fuel cells. Accordingly, researches in order to obtain a bio-fuel cell having a high output have been carried out (for example, see Japanese Unexamined Patent Application Publication Nos. 2006-234788, 2006-93090, and 2007-188810).

For example, in a bio-fuel cell disclosed in Japanese Unexamined Patent Application Publication No. 2006-234788, in order to increase the current density, an electrode is formed from a conductive member (such as a metal, a conductive polymer, a metal oxide, or a carbon material) having a porous structure, and an enzyme, an electron transfer mediator, and the like are immobilized in the pores thereof to increase an enzyme carrying density per effective area.

In a bio-fuel cell disclosed in Japanese Unexamined Patent Application Publication No. 2006-93090, in order to sufficiently obtain excellent electrode characteristics, a cathode electrode is formed from a porous material, such as carbon, and an enzyme and an electron transfer mediator immobilized thereon, and at least a part of this cathode electrode is configured to be in contact with air or oxygen, which functions as a reactive substrate in a gaseous phase.

In a bio-fuel cell disclosed in Japanese Unexamined Patent Application Publication No. 2007-188810, in order to increase the current density and the voltage, a plurality of cell portions is provided in one cell. In the bio-fuel cell disclosed in Japanese Unexamined Patent Application Publication No. 2007-188810, between spacers through which air is allowed to pass, a positive electrode collector, a positive electrode, a proton conductor, a negative electrode, a negative electrode collector, a spacer through which a fuel is allowed to pass, a negative electrode collector, a negative electrode, a proton conductor, a positive electrode, and a positive electrode collector are arranged in this order. That is, a cell portion formed of the positive electrode, the proton conductor, and the negative electrode and a cell portion formed of the negative electrode, the proton conductor, and the positive electrode are arranged so as to sandwich the spacer. In addition, an enzyme is immobilized on the negative electrodes, and a fuel holding container is provided so as to enclose the negative electrodes, the negative electrode collectors, and the spacer.

In the bio-fuel cell disclosed in Japanese Unexamined Patent Application Publication No. 2007-188810, for example, when a glucose solution is filled as a fuel in the fuel holding container, since glucose is decomposed by the enzyme on the negative electrodes, electrons are extracted, and in addition, H⁺ ions are generated. On the other hand, on the positive electrodes, the H+ ions transported through the proton conductors, the electrons extracted on the negative electrodes and transported through external circuits, and oxygen in the air react with each other, so that water is generated. In addition, when a load is connected between the negative electrode collector and the positive electrode collectors, a current flows therebetween, and a higher output than that in the past can be obtained.

As described above, in order to increase the output of the bio-fuel cell, various researches have been carried out; however, at present, the output thereof is still too low to be used for an actual electronic apparatus and the like. Therefore, it is necessary to increase the output by connecting a plurality of bio-fuel cells in series.

However, when bio-fuel cells are connected in series to increase the output, since a fuel has to be supplied to the plurality of bio-fuel cells, a fuel supply system becomes complicated, and as a result, a time necessary for power generation is disadvantageously increased.

Accordingly, the inventors of the present disclosure developed a technique which relates to a power supply device capable of realizing an increase in output by connecting at least two electrodes in series and which can simultaneously supply a fuel to the plurality of electrodes (see Japanese Unexamined Patent Application Publication No. 2009-140646). According to the technique disclosed in Japanese Unexamined Patent Application Publication No. 2009-140646, after the fuel is simultaneously supplied to negative electrodes, for example, an air layer is used as an ion isolation portion to ionically isolate between the negative electrodes.

### SUMMARY

In order to increase the output, when the bio-fuel cells are connected in series, and a fuel is simultaneously supplied to the negative electrodes as described above, the negative electrodes have to be ionically isolated from each other for power generation. In the power supply device previously developed by the present inventors, although a method for using an air layer as an ion isolation portion was proposed as one example, after fuel supply is performed, for example, a step of placing a power generation portion upside down has to be performed to form an air layer. That is, it was difficult to perform power generation without performing any operation after the fuel supply.

In addition, depending on the type of electronic apparatus to be used, it may be difficult to form an air layer in some cases.

Hence, it is desirable to provide a power supply device which can realize an increase in output by connecting at least two electrodes in series, which can simultaneously supply a fuel to the plurality of electrodes, and which can perform power generation without performing any operation after the fuel supply.

According to an embodiment of the present disclosure, there is provided a power supply device in which an enzyme is immobilized as a catalyst on negative electrodes and/or positive electrodes, which includes: electromotive portions in which at least two of the negative electrodes and the positive electrodes are connected in series; and a fuel supply portion which communicates with the negative electrodes and which simultaneously supplies a fuel to the negative electrodes, and in the power supply device, the fuel supply portion includes fuel-supply adjusting portions which adjust fuel supply to the negative electrodes.

In the power supply device according to the embodiment of the present disclosure, since the fuel-supply adjusting portions are provided, after a fuel is simultaneously supplied to the electrodes, without performing any particular operation, in the state after the fuel supply, power generation can be performed.

If the fuel-supply adjusting portion of the power supply device according to the embodiment of the present disclosure can adjust fuel supply to the negative electrodes, the structure of the fuel-supply adjusting portion is not particularly limited. For example, when the fuel diffusing portion is formed from a first fuel diffusing portion in contact with the corresponding negative electrode and a second fuel diffusing portion which is in contact with the corresponding first fuel diffusing portion and which has a low fuel diffusion rate as compared to that thereof, the fuel supply to the negative electrodes can be adjusted.

If the first fuel diffusing portion of the power supply device according to the embodiment of the present disclosure can diffuse and supply a fuel to the corresponding negative electrode, the structure of the first fuel diffusing portion is not particularly limited. For example, the first fuel diffusing portion may be formed using a material, such as, paper, cloth, a flow path, a polymer, or a hydrophilic coating material.

In addition, when the second fuel diffusing portion of the power supply device according to the embodiment of the present disclosure is formed from a material having a low fuel diffusion rate compared to that of the first fuel diffusing portion, the material of the second fuel diffusing portion is not particularly limited. For example, the second fuel diffusing portion may be formed using a material, such as paper, cloth, a flow path, a polymer, a hydrophilic coating material, or a hydrophobic coating material.

When modes of the first fuel diffusing portions and/or the second fuel diffusing portions of the power supply device according to the embodiment of the present disclosure are made different from each other, fuel diffusion times from a fuel injection portion to the negative electrodes are also made different from each other, and hence the timing of power generation can be shifted between the electromotive portions.

As a method for shifting the timing of power generation between the electromotive portions, for example, there may be mentioned a method in which the shapes of the first fuel diffusing portions and/or the second fuel diffusing portions are made different from each other so that the distances from the fuel injection portion to the negative electrodes are different from each other and a method in which water repellencies of the first fuel diffusing portions and/or the second fuel diffusing portions are made different from each other.

In addition, the negative electrodes and the positive electrodes may be connected in parallel to at least one of the first fuel diffusing portions of the power supply device according to the embodiment of the present disclosure. In this case, when the distances from the fuel injection portion to the negative electrodes are made different from each other, the fuel diffusion times from the fuel injection portion to the negative electrodes are also made different from each other, and hence the timing of power generation can be shifted between the electromotive portions.

The power supply device according to the embodiment of the present disclosure may further include an ion isolation portion which ionically isolates between the negative electrodes.

The enzyme immobilized on the negative electrodes may at least contain an oxidase.

In addition, the enzyme immobilized on the negative electrodes may at least contain an oxidized coenzyme.

When the enzyme immobilized on the negative electrodes at least contains an oxidized coenzyme, a coenzyme oxidase may be further contained.

In addition, besides the enzyme described above, an electron transfer mediator may also be immobilized on the negative electrodes and/or the positive electrodes.

According to an embodiment of the present disclosure, there is provided an electronic apparatus using fuel cells in which an oxidoreductase is immobilized as a catalyst on negative electrode and/or positive electrodes, which includes a fuel cell portion in which at least two fuel cells are connected in series; and a fuel supply portion which communicates with the negative electrodes of the fuels cells and which simultaneously supplies a fuel to the negative electrodes, and the fuel supply portion includes fuel-supply adjusting portions which adjust fuel supply to the negative electrodes.

In the power supply device according to the embodiment of the present disclosure, since at least two electrodes are connected in series, high output current and voltage can be obtained, and in addition, since a fuel can be simultaneously supplied to the negative electrodes, a fuel can be easily supplied, and stable power generation can be performed within a short time.

Additional features and advantages are described herein, and will be apparent from the following Detailed Description and the figures.

### BRIEF DESCRIPTION OF THE FIGURES

FIG. 1 is a schematic cross-sectional view showing a power supply device 1 according to a first embodiment of the present disclosure;

FIG. 2 includes schematic cross-sectional views each showing an example of the state of fuel supply in the power supply device 1 according to the first embodiment of the present disclosure, a part (I) of FIG. 2 shows the power supply device 1 immediately after fuel injection, a part (II) of FIG. 2 shows the power supply device 1 in the state in which a fuel is being supplied to first fuel diffusing portions 311a and 311b, and a part (III) of FIG. 2 shows the power supply device 1 after the fuel supply to the first fuel diffusing portions 311a and 311b is completed;

FIG. 3 is a schematic cross-sectional view showing a power supply device 1 according to a second embodiment of the present disclosure;

FIG. 4 is a schematic top view showing a power supply device 1 according to a third embodiment of the present disclosure;

FIG. 5 is a schematic top view showing a power supply device 1 according to a fourth embodiment of the present disclosure;

FIG. 6 is a schematic top view showing a power supply device 1 according to a fifth embodiment of the present disclosure;

FIG. 7 is an image of a graph used instead of drawing which shows the state of power generation performed by using the power supply device 1 according to the fifth embodiment of the present disclosure;

FIG. 8 is a schematic top view showing a power supply device 1 according to a sixth embodiment of the present disclosure;

FIG. 9 is a graph used instead of drawing which shows a permeation rate when the capillary radius of a fuel diffusing portion is 200 μm, the surface tension of a fuel is 72 mN/m, and the viscosity thereof is 2 mPa·s;

FIG. 10 is a schematic top view showing a power supply device 1 according to a seventh embodiment of the present disclosure; and

FIG. 11 includes schematic cross-sectional views each showing an example of the state of fuel supply in a power supply device including no fuel-supply adjusting portions 31a and 31b, a part (I) of FIG. 11 shows the power supply device immediately after fuel injection, a part (II) of FIG. 11 shows the power supply device in the state in which a fuel is being supplied to first fuel diffusing portions 311a′ and 311b′, and a part (III) of FIG. 11 shows the power supply device after the fuel supply to the first fuel diffusing portions 311a′ and 311b′ is completed.

### DETAILED DESCRIPTION

Hereinafter, preferable embodiments of the present disclosure will be described with reference to the drawings. However, the embodiments of the present disclosure described below are shown by way of example, and it is to be understood that the scope of the present disclosure is not narrowed thereby. Description will be made in the following order.
1. Power supply device 1
(1) Electromotive portions 2a, 2b
(2) Fuel supply portion 3
(3) Ion isolation portion 4
2. Electronic apparatus

<1. Power Supply Device>

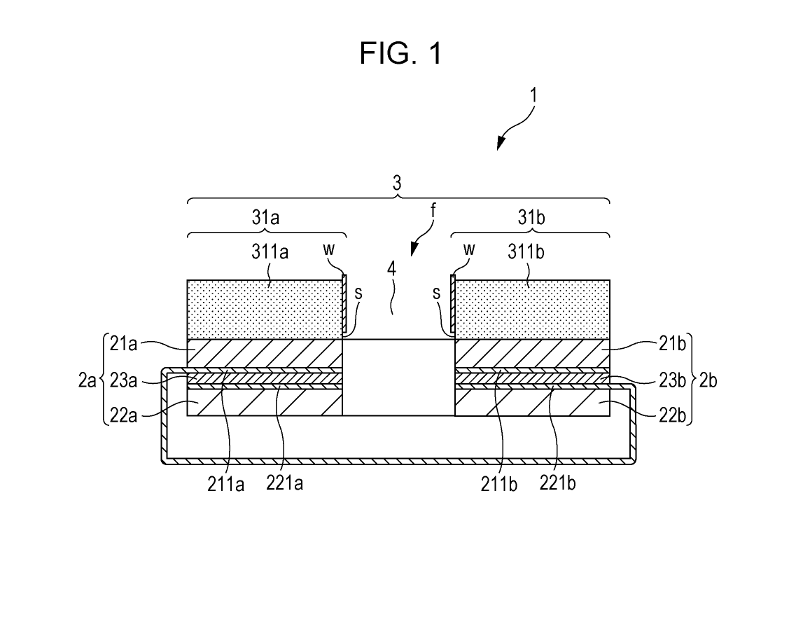

FIG. 1 is a schematic cross-sectional view showing a power supply device according to a first embodiment of the present disclosure. A power supply device 1 according to the embodiment of the present disclosure roughly includes electromotive portions 2a and 2b and a fuel supply portion 3. In particular, in the present disclosure, the fuel supply portion 3 includes fuel-supply adjusting portions 31a and 31b. In addition, the power supply device according to the embodiment of the present disclosure may further include an ion isolation portion 4. Hereinafter, the structure, the function, the effect, and the like of each portion will be described.

(1) Electromotive Portions 2a and 2b

The electromotive portion 2a has a structure in which a negative electrode 21a faces a positive electrode 22a with a proton conductor 23a provided therebetween, and the electromotive portion 2b has a structure in which a negative electrode 21b faces a positive electrode 22b with a proton conductor 23b provided therebetween. In the power supply device 1 according to this embodiment, although a negative electrode collector 211a is provided between the negative electrode 21a and the proton conductor 23a, and a negative electrode collector 211b is provided between the negative electrode 21b and the proton conductor 23b, the locations of the negative electrode collectors 211a and 211b are not particularly limited. If each having a structure through which a fuel is allowed to pass, the negative electrode collectors 211a and 211b may be provided between the negative electrode 21a and the fuel supply portion 3 and between the negative electrode 21b and the fuel supply portion 3, respectively. Incidentally, the fuel supply portion 3 will be described later.

In addition, in the power supply device 1 according to this embodiment, although a positive electrode collector 221a is provided between the positive electrode 22a and the proton conductor 23a, and a positive electrode collector 221b is provided between the positive electrode 22b and the proton conductor 23b, the locations of the positive electrode collectors 221a and 221b are not particularly limited. If each having a structure through which, for example, air containing oxygen is allowed to pass, the positive electrode collectors 221a and 221b may be provided at lower sides of the positive electrodes 22a and 22b, respectively, shown in FIG. 1.

In the power supply device 1 according to this embodiment, although two of the electrodes (the negative electrodes 21a and 21b and the positive electrodes 22a and 22b) are connected in series, if at least two electrodes (the negative electrodes 21a and 21b and the positive electrodes 22a and 22b) are connected in series, the number of the electrodes is not particularly limited. In accordance with a necessary electric power, the number of the electrodes (the negative electrodes 21a and 21b and the positive electrodes 22a and 22b) may be freely designed and/or modified.

A connection method of the electrodes (the negative electrodes 21a and 21b and the positive electrodes 22a and 22b) is not particularly limited as long as series connection is performed. For example, as shown in FIG. 1, at least two electrodes (the negative electrodes 21a and 21b and the positive electrodes 22a and 22b) can be connected in series when the negative electrode collector 211a of one electrode is connected to the positive electrode collector 221b of the other electrode.

In the electromotive portions 2a and 2b, electrons are emitted by an oxidation reaction of a fuel on the negative electrodes 21a and 21b, the electrons moves to the positive electrodes 22a and 22b through the negative electrode collectors 211a and 211b and the positive electrode collectors 221a and 221b, respectively, and a reduction reaction occurs on the positive electrodes 22a and 22b using the electrons and oxygen supplied from the outside, so that electric energy is generated by this series of reactions.

As a material used for the negative electrodes 21a and 21b, any commonly used materials may be used and are not particularly limited as long as being electrically connectable to the outside, and for example, there may be mentioned metals, such as Pt, Ag, Au, Ru, Rh, Os, Nb, Mo, In, Ir, Zn, Mn, Fe, Co, Ti, V, Cr, Pd, Re, Ta, W, Zr, Ge, and Hf; alloys, such as alumel, brass, duralumin, bronze, nickelin, platinum rhodium, Hiperco, permalloy, Permendur, nickel silver, and phosphor bronze; conductive polymers, such as a polyacetylene; carbon materials, such as graphite and carbon black; borides, such as HfB₂, NbB, CrB₂, and B₄C; nitrides, such as TiN and ZrN; silicides, such as VSi₂, NbSi₂, MoSi₂, and TaSi₂; and mixtures of those mentioned above.

An enzyme may be immobilized on the negative electrodes 21a and 21b as necessary. For example, when a fuel containing saccharides is used as a fuel, an oxidase which decomposes saccharides by oxidation may be immobilized. As examples of the oxidase, glucose dehydrogenase, gluconate 5-dehydrogenase, gluconate 2-dehydrogenase, alcohol dehydrogenase, aldehyde reductase, aldehyde dehydrogenase, lactate dehydrogenase, hydroxy pyruvate reductase, glycerate dehydrogenase, formate dehydrogenase, fructose dehydrogenase, galactose dehydrogenase, and the like may be mentioned.

In addition, besides the oxidase mentioned above, an oxidized coenzyme and a coenzyme oxidase may also be immobilized on the negative electrodes 21a and 21b. As the oxidized coenzyme, for example, nicotinamide adenine dinucleotide (hereinafter, referred to as “NAD+”), nicotinamide adenine dinucleotide phosphate (hereinafter, referred to as “NADP+”), flavin adenine dinucleotide (hereinafter, referred to as “FAD+”), and pyrrolo-quinoline quinone (hereinafter, referred to as “PQQ2+”) may be mentioned. As the coenzyme oxidase, for example, diaphorase may be mentioned.

Along with oxidative decomposition of a fuel, on the negative electrodes 21a and 21b, the above oxidized coenzymes are reduced to NADH, NADPH, FADH, and PQQH2, which are the respective reduced types, and conversely, by the coenzyme oxidase, the reduced coenzyme is returned to the oxidized coenzyme, so that an oxidation-reduction reaction is repeatedly performed. In this reaction, when the reduced coenzyme is returned to the oxidized coenzyme, two electrons are generated.

In addition, besides the above oxidase and oxidized coenzyme, an electron transfer mediator may also be immobilized on the negative electrodes 21a and 21b. The reason for this is to smoothly transfer the electrons thus generated to the electrode. As the electron transfer mediator, for example, 2-amino-3-carboxy-1,4-naphthoquinone (ACNQ), Vitamin K3, 2-amino-1,4-naphthoquinone (ANQ), 2-amino-3-methyl-1,4-naphthoquinone (AMNQ), 2,3 -diamino-1,4-naphthoquinone, anthraquinone-l-sulfonic acid, anthraquinone-2-sulfonic acid, metal complexes of osmium (Os), ruthenium (Ru), iron (Fe), cobalt (Co), and the like, viologen compounds, such as benzyl viologen, a compound having a quinone skeleton, a compound having a nicotinamide structure, a compound having a riboflavin structure, and a compound having a nucleotide-phosphoric acid structure may be mentioned.

As a material used for the positive electrodes 22a and 22b, any commonly used materials may also be used and are not particularly limited as long as being electrically connectable to the outside, and for example, there may be mentioned metals, such as Pt, Ag, Au, Ru, Rh, Os, Nb, Mo, In, Ir, Zn, Mn, Fe, Co, Ti, V, Cr, Pd, Re, Ta, W, Zr, Ge, and Hf; alloys, such as alumel, brass, duralumin, bronze, nickelin, platinum rhodium, Hiperco, permalloy, Permendur, nickel silver, and phosphor bronze; conductive polymers, such as a polyacetylene; carbon materials, such as graphite and carbon black; borides, such as HfB₂, NbB, CrB₂, and B₄C; nitrides, such as TiN and ZrN; silicides, such as VSi₂, NbSi_{z}, MoSi₂, and TaSi₂; and mixtures of those mentioned above.

An enzyme may also be immobilized on the positive electrodes 22a and 22b as necessary. As the enzyme which can be immobilized on the positive electrodes 22a and 22b, an oxidase having oxidase activity which uses oxygen as a reactive substrate may be freely selected as necessary, and the type thereof is not particularly limited. For example, laccase, bilirubin oxidase, and ascorbate oxidase may be used.

In addition to the above enzymes, an electron transfer mediator may also be immobilized on the positive electrodes 22a and 22b. The reason for this is to smoothly receive electrons which are generated on the negative electrodes 21a and 21b and which are transferred through the negative electrode collectors 211a and 211b and the positive electrode collectors 221a and 221b. The type of electron transfer mediator which can be immobilized on the positive electrodes 22a and 22b is not particularly limited and can be freely selected as necessary. For example, ABTS (2,2′-azinobis(3-ethylbenzoline-6-sulfonate)) and K3[Fe(CN)₆] may be used.

On the positive electrodes 22a and 22b, a reduction reaction progresses using electrons transferred from the negative electrodes 21a and 21b through the negative electrode collectors 211a and 211b and the positive electrode collectors 221a and 221b and oxygen supplied from the outside.

A material used for the proton conductors 23a and 23b is not particularly limited, any commonly used materials may be used, and for example, an electrolyte containing a buffer substance may be used. As the buffer substance, for example, there may be mentioned dihydrogenphosphate ions (H₂PO₄-) generated, for example, from sodium dihydrogenphosphate (NaH₂PO₄) or potassium dihydrogenphosphate (KH₂PO₄), 2 -amino-2-hydroxymethyl-1,3 -propanediol (abbreviation: tris), 2-(N-morpholino)ethanesulfonic acid (MES), cacodylic acid, carbonic acid (H₂CO₃), hydrogen citrate ions, N-(2-acetamido) iminodiacetic acid (ADA), piperazine-N,N′-bis(2-ethane sulfonic acid) (PIPES), N-(2-acetamido)-2-aminoethanesulfonic acid (ACES), 3-(N-morpholino)propanesulfonic acid (MOPS), N-2-hydroxyethyl piperazine-N′-2-ethanesulfonic acid (HEPES), N-2-hydroxyethyl piperazine-N′-3-propanesulfonic acid (HEPPS), N-[tris(hydroxymethyl)methyl]glycine (abbreviation: tricine), glycylglycine, N,N-bis(2-hydroxyethyl)glycine (abbreviation: bicine), imidazole, triazole, a pyridine derivative, a bipyridine derivative, and compounds each containing an imidazole ring, such as imidazole derivatives (histidine, 1-methylimidazole, 2-methylimidazole, 4-methylimidazole, 2-ethylimidazole, imidazole-2-ethyl carboxylate, imidazole-2-carboxyaldehyde, imidazole-4-carboxylic acid, imidazole-4,5-dicarboxylic acid, imidazole-1-yl-acetic acid, 2-acetyl benzimidazole, 1-acetylimidazole, N-acetylimidazole, 2-amino benzimidazole, N-(3 -aminopropyl)imidazole, 5-amino-2-(trifluoromethyl)benzimidazole, 4-azabenzimidazole, 4-aza-2-mercaptobenzimidazole, benzimidazole, 1-benzylimidazole, and 1-butylimidazole).

As a material used for the negative electrode collectors 211a and 211b and the positive electrode collectors 221a and 221b, any commonly used materials may also be used and are not particularly limited as long as being electrically connectable to the outside, and for example, there may be mentioned metals, such as Pt, Ag, Au, Ru, Rh, Os, Nb, Mo, In, Ir, Zn, Mn, Fe, Co, Ti, V, Cr, Pd, Re, Ta, W, Zr, Ge, and Hf; alloys, such as alumel, brass, duralumin, bronze, nickelin, platinum rhodium, Hiperco, permalloy, Permendur, nickel silver, and phosphor bronze; conductive polymers, such as a polyacetylene; carbon materials, such as graphite and carbon black; borides, such as HfB₂, NbB, CrB₂, and B₄C; nitrides, such as TiN and ZrN; silicides, such as VSi₂, NbSi₂, MoSi₂, and TaSi₂; and mixtures of those mentioned above.

(2) Fuel Supply Portion 3

The fuel supply portion 3 is a portion to simultaneously supply a fuel necessary for power supply to negative electrodes. As shown in the first embodiment of FIG. 1, since the fuel supply portion of the power supply device 1 according to the embodiment of the present disclosure is formed to communicate with the negative electrodes 21a and 21b of the electromotive portions 2a and 2b, respectively, connected in series, the fuel supply can be simultaneously performed to the negative electrodes 21a and 21b.

In addition, in particular, according to the present disclosure, the fuel supply portion 3 includes fuel-supply adjusting portions 31a and 31b. In the first embodiment, as the fuel-supply adjusting portions 31a and 31b, there are provided first fuel diffusing portions 311a and 311b which are in contact with the negative electrodes 21a and 21b, respectively, and which diffuse a fuel thereto, and adjustment walls w which blocks the flow of a fuel between a fuel injection portion f and the first fuel diffusing portions 311a and 311b. Between this adjustment walls w and the respective first fuel diffusing portions 311a and 311b, there are provided fuel introducing holes s for gradually introducing a fuel into the first fuel diffusing portions 311a and 311b from the fuel injection portion f.

The size of this fuel introducing hole s is not particularly limited and can be freely designed in accordance with the type of fuel to be used, the difference in viscosity thereof, the difference in fuel diffusion rate between the first fuel diffusing portions 311a and 311b, and/or the target fuel introduction rate. For example, by moving the adjustment wall w in an up and down direction in FIG. 1, the size of the fuel introducing hole s can be designed to be adjustable.

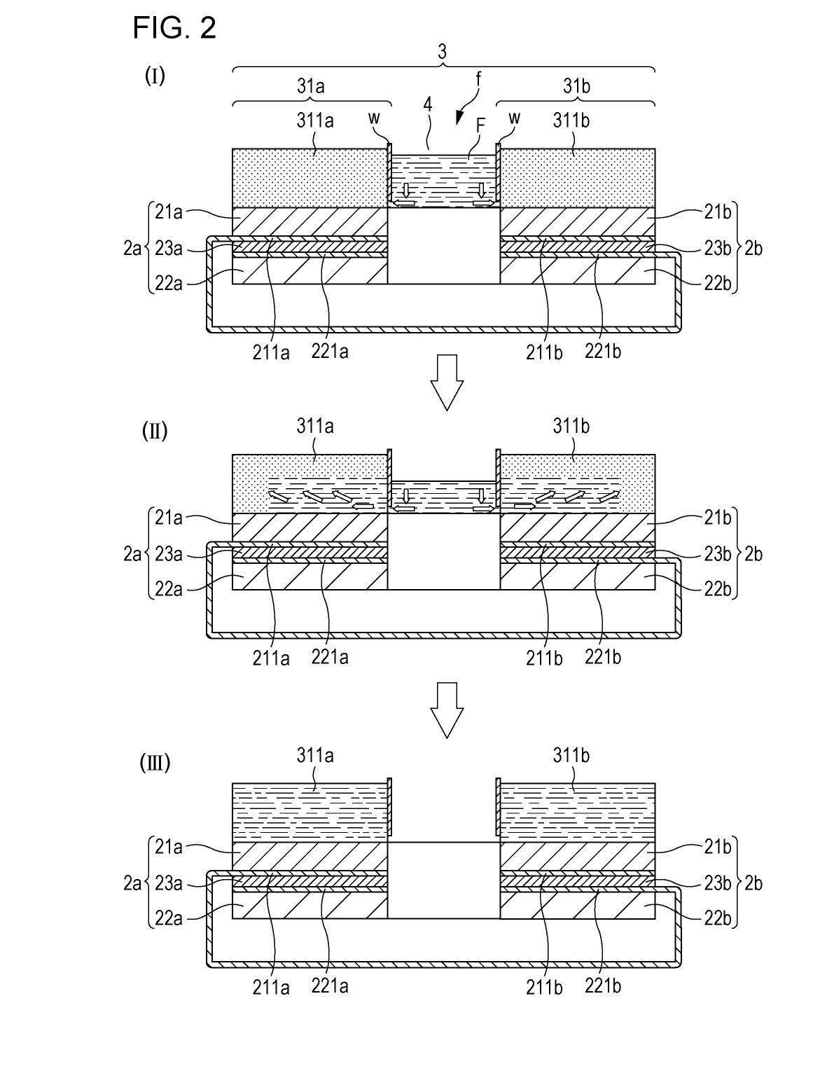

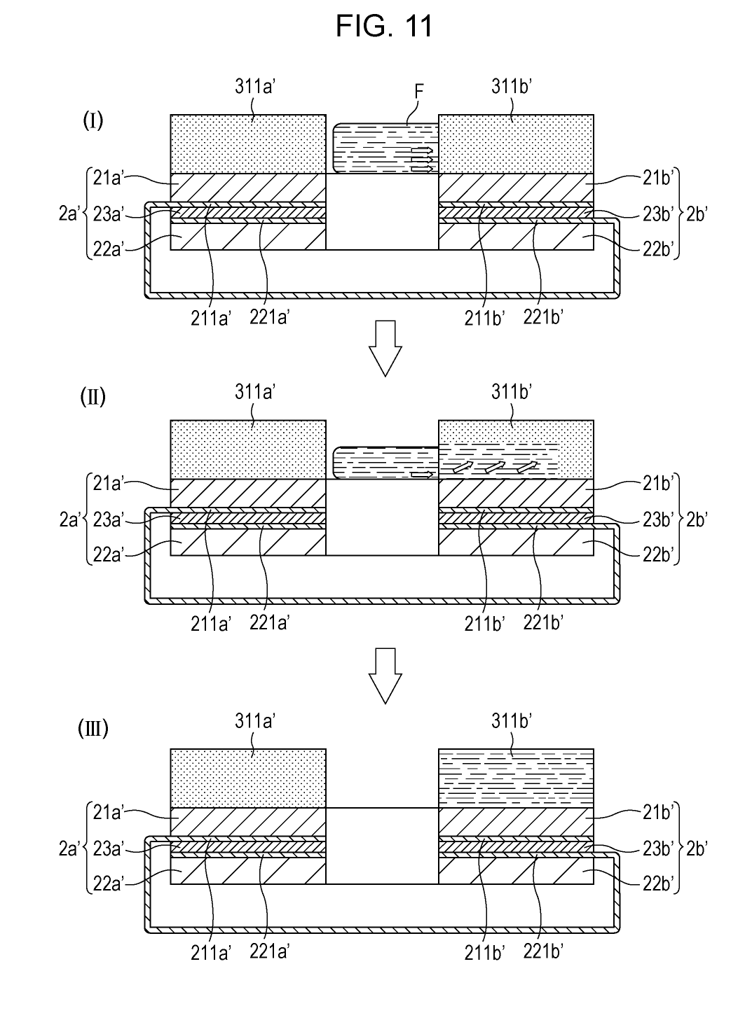

In the power supply device 1 according to the embodiment of the present disclosure, since the fuel-supply adjusting portions 31a and 31b are provided, the fuel supply can be simultaneously and equally performed to the negative electrodes 21a and 21b. One example of the state of the fuel supply in the power supply device 1 according to the embodiment of the present disclosure will be described with reference to FIG. 2 and FIG. 11.

FIG. 2 includes schematic cross-sectional views each showing an example of the state of the fuel supply in the power supply device 1 according to the embodiment of the present disclosure. In addition, FIG. 11 includes schematic cross-sectional views each showing an example of the state of fuel supply in a power supply device having no fuel-supply adjusting portions 31a and 31b. In each of FIGS. 2 and 11, a part (I) of the figure shows the power supply device immediately after the fuel injection, and a part (II) of the figure shows the power supply device in which a fuel is being introduced into the first fuel diffusing portions 311a and 311b or into first fuel diffusing portions 311a′ and 311b′, and a part (III) of the figure shows the power supply device in which the fuel introduction into the first fuel diffusing portions 311a and 311b or into the first fuel diffusing portions 311a′ and 311b′ is completed.

As shown in FIG. 11, when no fuel-supply adjusting portions 31a and 31b are provided, depending on fuel injection rate and angle, the case is liable to occur in which a fuel is only absorbed into one first fuel diffusing portion 311b′ and is not supplied to the other first fuel diffusing portion 311a′. Even if fuel absorption does not occur only at one side, a difference in fuel absorbed amount may arise between the first fuel diffusing portions 311a′ and 311b′ in some cases; hence, a difference in production of electricity may arise between electromotive portion 2a′ and 2b′. As a result, in the power supply device in which the electromotive portions 2a′ and 2b′ are arranged in series, a problem in that power supply is not well performed may occur.

On the other hand, as shown in FIG. 2, in the power supply device 1 according to the embodiment of the present disclosure including the fuel-supply adjusting portions 31a and 31b, since gradually introduced into the first fuel diffusing portion 311a and 311b by the fuel-supply adjusting portions 31a and 31b, a fuel can be simultaneously and equally supplied to the first fuel diffusing portions 311a and 311b and consequently to the negative electrode 21a and 21b. That is, regardless of injection techniques, such as the fuel injection rate and angle, a fuel can be simultaneously and equally supplied to the negative electrode 21a and 21b. As a result, easy and stable power supply can be realized.

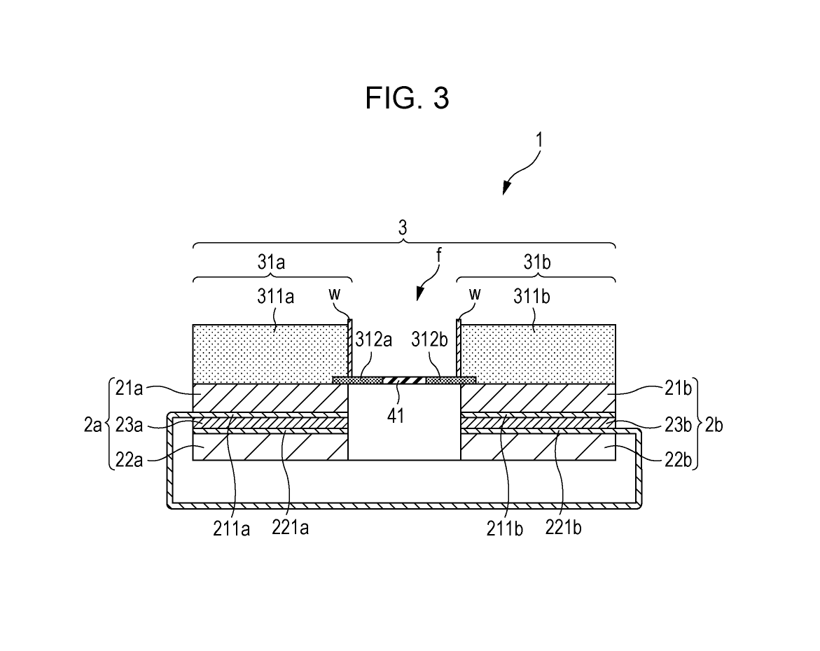

The fuel-supply adjusting portions 31a and 31b are not limited to the structure of the power supply device 1 according to the first embodiment and are not particularly limited if a fuel can be gradually introduced into the negative electrode 21a and 21b. Hereinafter, another example of the fuel-supply adjusting portions 31a and 31b will be described with reference to FIG. 3.

FIG. 3 is a schematic cross-sectional view showing a power supply device 1 according to a second embodiment of the present disclosure. In the power supply device 1 according to the second embodiment of the present disclosure, as the fuel-supply adjusting portions 31a and 31b, the first fuel diffusing portions 311a and 311b which are in contact with the respective negative electrodes 21a and 21b and which diffuse a fuel thereto and second fuel diffusing portions 312a and 312b communicating with the respective first fuel diffusing portions 311a and 311b are provided.

These second fuel diffusing portions 312a and 312b are each adjusted so that the fuel diffusion rate is low as compared to that of the first fuel diffusing portion. Since the fuel diffusion rates of the second fuel diffusing portions 312a and 312b are each adjusted low as compared to that of the first fuel diffusing portion, a fuel is gradually introduced into the first fuel diffusing portion 311a and 311b. As a result, a fuel can be simultaneously and equally supplied to the first fuel diffusing portions 311a and 311b and consequently to the negative electrode 21a and 21b.

If the first fuel diffusing portions 311a and 311b are each able to diffuse and supply a fuel to the respective negative electrodes, the structure thereof is not particularly limited. For example, the first fuel diffusing portions 311a and 311b may be formed by using a material, such as paper, cloth, a flow path, a polymer, or a hydrophilic coating material. In more particular, for example, there may be used clothes, such as cotton, linen, feather, silk, Tencel, cupra, rayon, polynosic, acetate, triacetate, promix, nylon, polyester, acrylic resin, and polyurethane; carbon fiber materials processed by a hydrophilic treatment; hydrophilic polymers, such as gelatin, collagen gel, casein, agar, starch, poly(vinyl alcohol), poly(acrylic acid), polyacrylamide, carboxymethyl cellulose, hydroxyethyl cellulose, poly(vinyl pyrrolidone), and dextran; and a hydrophilic coating agent, such as a titanium oxide film.

In addition, the locations of the first fuel diffusing portions 311a and 311b of the power supply device 1 are not limited. If a fuel can be supplied to the negative electrodes 21a and 21b, unlike the first and the second embodiments in which the first fuel diffusing portions 311a and 311b are provided at upper sides of the negative electrode 21a and 21b, respectively, as shown in FIGS. 1 and 3, for example, the first fuel diffusing portions 311a and 311b may be arranged between the negative electrode 21a and the positive electrode 22a and between the negative electrode 21b and the positive electrode 22b, respectively.

If the second fuel diffusing portions 312a and 312b are formed from a material having a low fuel diffusion rate compared to that of the above first fuel diffusing portions 311a and 311b, the material is not particularly limited. The second fuel diffusing portions 312a and 312b may be formed by using a material, such as paper, cloth, a flow path, a polymer, a hydrophilic coating material, or a hydrophobic coating material. In more particular, for example, there may be used clothes, such as cotton, linen, feather, silk, Tencel, cupra, rayon, polynosic, acetate, triacetate, promix, nylon, polyester, acrylic resin, and polyurethane; carbon fiber materials processed by a hydrophilic treatment; hydrophilic polymers, such as gelatin, collagen gel, casein, agar, starch, poly(vinyl alcohol), poly(acrylic acid), polyacrylamide, carboxymethyl cellulose, hydroxyethyl cellulose, poly(vinyl pyrrolidone), and dextran; and a hydrophilic coating agent, such as a titanium oxide film.

In addition, although the first fuel diffusing portions 311a and 311b and the second fuel diffusing portions 312a and 312b may be formed from materials having different diffusion rates, when the diffusion rate can be changed by processing the same material, the first and the second fuel diffusing portions may also be formed from the same material.

For example, the first fuel diffusing portions 311a and 311b are formed using cupra having water absorbability, and when parts thereof are pressed so as to partially decrease the fuel diffusion rate, the second fuel diffusing portions 312a and 312b can be formed therefrom.

Alternatively, for example, when the first fuel diffusing portions 311a and 311b are each formed from a flow path, and the second fuel diffusing portions 312a and 312b are each formed from a flow path smaller than that described above, the diffusion rate can be adjusted.

In the power supply device 1 according to the second embodiment of the present disclosure described above, after the fuel supply, since a fuel is held in the first fuel diffusing portions 311a and 311b, during power generation, no fuel flows backwards or leaks out.

In addition, even in the power supply device 1 according to the first embodiment including no second fuel diffusing portions 312a and 312b, when a high viscous fuel is used, since being able to be held in the first fuel diffusing portions 311a and 311b, during power generation, the fuel can be prevented from flowing backwards or leaking out.

In the first and the second embodiments shown in FIGS. 1 and 3, respectively, although the structure is formed so that a fuel is directly injected into the fuel injection portion f, the fuel injection method is not limited thereto. For example, although not shown in the figure, the structure may also be formed in such a way that a fuel storage portion is formed in the power supply device 1, and a fuel is stored therein and is then injected into the fuel injection portion f when necessary. Alternatively, the structure may also be formed in such a way that a detachable fuel cartridge which stores a fuel is provided in the power supply device 1 when necessary, and a fuel is supplied to the fuel injection portion f.

(3) Ion Isolating Portion 4

Although being not indispensable in the power supply device 1 according to the embodiment of the present disclosure, the ion isolation portion 4 may be provided to ionically isolate between the negative electrodes 21a and 21b after a fuel is supplied thereto. As described above, since the negative electrode 21a communicates with the negative electrode 21b through the fuel supply portion 3 provided therebetween, when a fuel is supplied, because of electrolytic characteristics thereof, ions move between the negative electrodes 21a and 21b through a fuel, so that power generation may not be carried out. Accordingly, as is the power supply device 1 according to the embodiment of the present disclosure, after a fuel is supplied, measures to ionically isolate between the negative electrode 21a and the negative electrode 21b has to be provided.

After a fuel is supplied to the negative electrodes 21a and 21b, when the negative electrode 21a and negative electrode 21b can be ionically isolated from each other, the structure of the ion isolation portion 4 is not particularly limited and can be freely designed. For example, as is the first embodiment shown in FIG. 1, since no fuel is present in the fuel injection portion f after the fuel supply, this fuel injection portion fin this state may be used as the ion isolation portion 4.

In addition, as is the second embodiment shown in FIG. 3, besides the fuel injection portion f, for example, when an ion insulator 41 is provided between the second fuel diffusing portions 312a and 312b, the negative electrode 21a and the negative electrode 21b can be reliably ionically isolated from each other.

As described above, since the negative electrode 21a and 21b can be ionically isolated in the power supply device 1 according to the present disclosure without performing any operation after the fuel supply, in the state thereafter, power generation can be immediately performed.

According to the first embodiment and the second embodiment described above, although the two electromotive portions 2a and 2b are connected in series, the number thereof is not particularly limited. In accordance with a necessary electric power, the number of the electromotive portions 2a and 2b may be freely designed and/or modified.

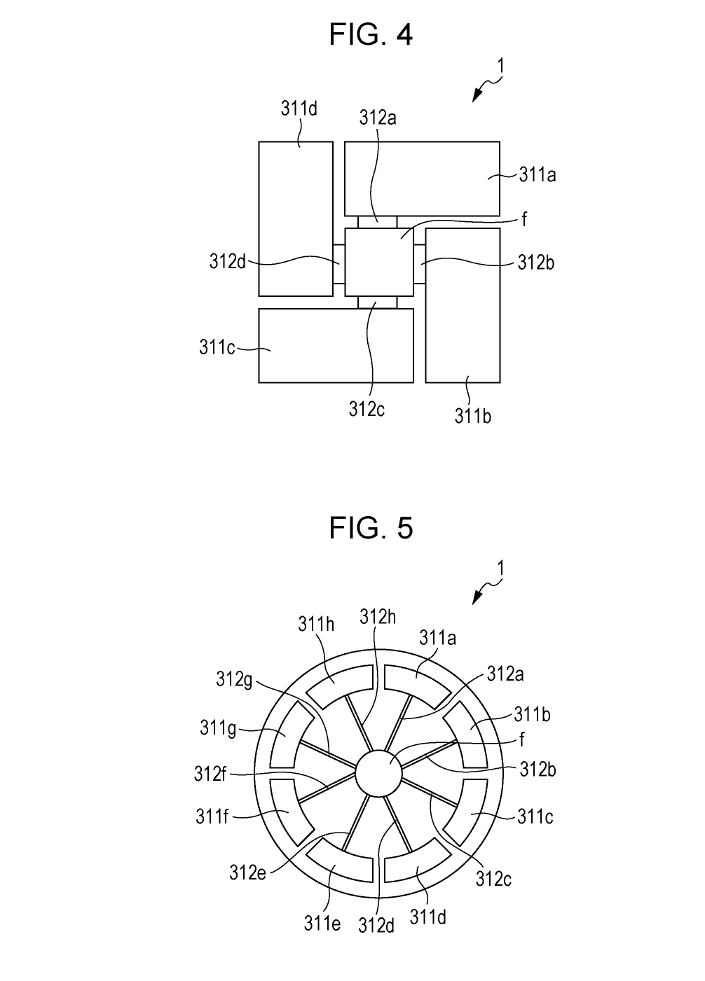

For example, as is a power supply device 1 according to a third embodiment shown in FIG. 4, the structure may be designed so as to connect four electromotive portions in series. FIG. 4 is a top view showing the power supply device 1 according to the third embodiment of the present disclosure, and behind first fuel diffusing portions 311a, 311b, 311c, and 311d in the direction to the plane of the figure, although being not shown in the figure, the four electromotive portions are arranged.

In addition, for example, as is a power supply device 1 according to a fourth embodiment shown in FIG. 5, the structure may also be designed so that eight electromotive portions connected in series are arranged on a circular substrate. FIG. 5 is a top view showing the power supply device 1 according to the fourth embodiment of the present disclosure, and behind first fuel diffusing portions 311a, 311b, 311c, 311d, 311e, 311f, 311g, and 311h in the direction to the plane of the figure, although being not shown in the figure, the eight electromotive portions are arranged. In addition, second fuel diffusing portions 312a, 312b, 312c, 312d, 312e, 312f, 312g, and 312h are each formed using a flow path.

The power supply device 1 according to the embodiment of the present disclosure includes a plurality of the electromotive portions 2a and 2b. By using this characteristic structure, for example, it can be design to shift the timing of power generation between the electromotive portions 2a and 2b. As a method for adjusting the timing of power generation, for example, when modes of the first fuel diffusing portions 311a, 311b, 311c, 311d, 311e, 311f, 311g, 311h, and/or the second fuel diffusing portions 312a, 312b, 312c, 312d, 312e, 312f, 312g, and 312h of the power supply device 1 according to the embodiment of the present disclosure are made different from each other, fuel diffusion times from the fuel injection portion f to the negative electrodes 21a and 21b are also made different from each other, and hence the timing of power generation between the electromotive portion 2a and 2b can be adjusted. Hereinafter, a method for adjusting the timing of power generation will be described with reference to concrete examples.

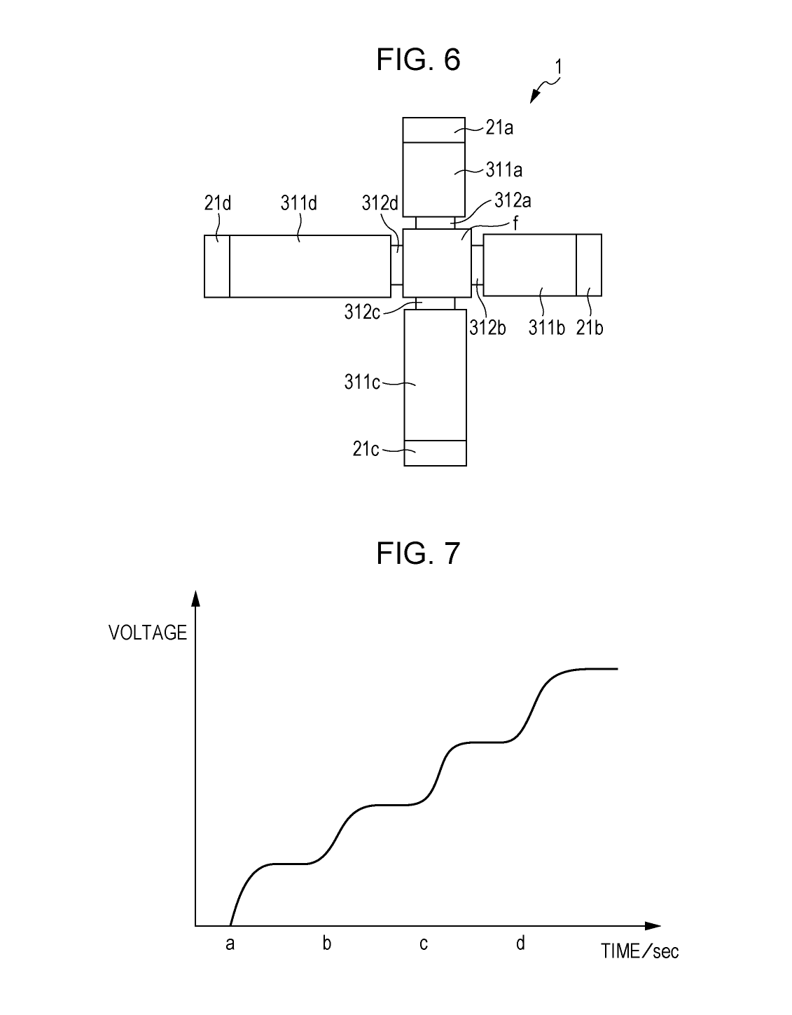

FIG. 6 is a schematic top view showing a power supply device 1 according to a fifth embodiment of the present disclosure. In the power supply device 1 according to the fifth embodiment, the shapes of the first fuel diffusing portions 311a, 311b, 311c and 311d are made different from each other, so that the distances from the fuel injection portion f to negative electrodes 21a, 21b, 21c, and 21d are also made different from each other. When the distances from the fuel injection portion f to the negative electrode 21a, 21b, 21c, and 21d are made different from each other as described above, the fuel diffusion times from the fuel injection portion f to the negative electrode 21a, 21b, 21c, and 21d are also made different from each other, and as a result, as a graph image used instead of drawing shown in FIG. 7, the timing of power generation can be shifted between the electromotive portions (in the figure, only the negative electrodes 21a, 21b, 21c, and 21d are shown).

Although the shapes of the first fuel diffusing portions 311a, 311b, 311c, and 311d are made different from each other in the fifth embodiment, besides the above structure, the structure may also be freely designed in such a way that the shapes of the second fuel diffusing portions 312a, 312b, 312c, and 312d are made different from each other so that the distances from the fuel injection portion f to the negative electrode 21a, 21b, 21c, and 21d are different from each other.

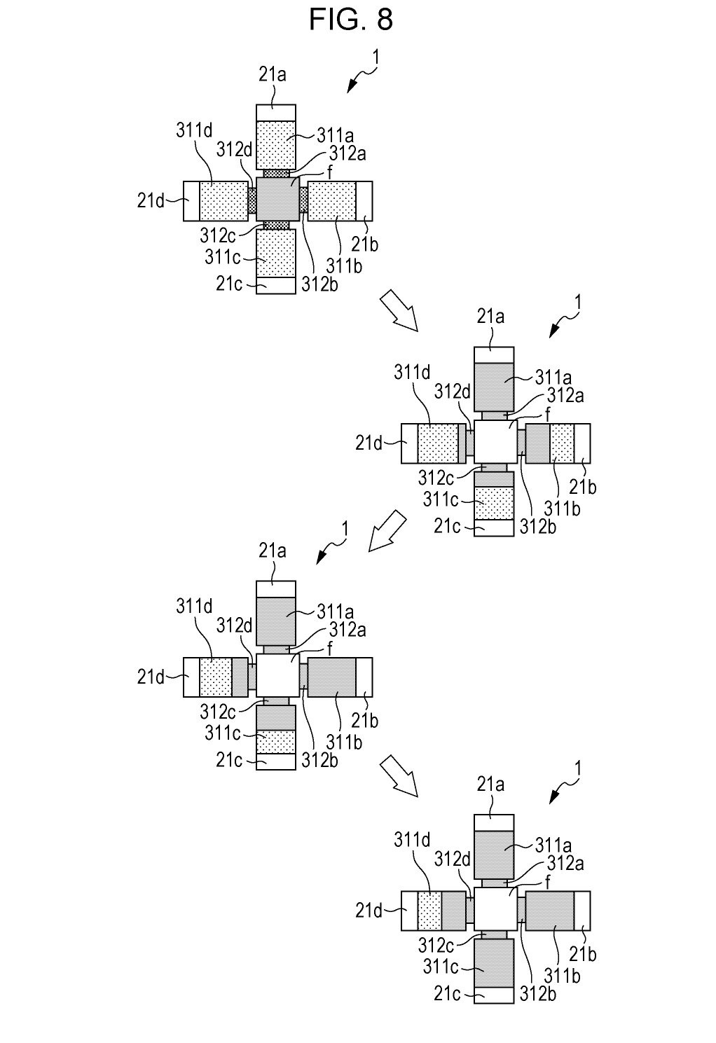

As a method for adjusting the timing of power generation between the electromotive portions, besides the method described in the fifth embodiment in which the distances from the fuel supply portion to the negative electrodes are made different from each other by forming the shapes of the first fuel diffusing portions and/or the second fuel diffusing portions different from each other, for example, a method may also be designed as described in the following sixth embodiment shown in FIG. 8.

FIG. 8 is a schematic top view showing a power supply device 1 according to the sixth embodiment of the present disclosure. In the sixth embodiment, as one example, water repellencies of the first fuel diffusing portions 311a, 311b 311c, and 311d are made different from each other.

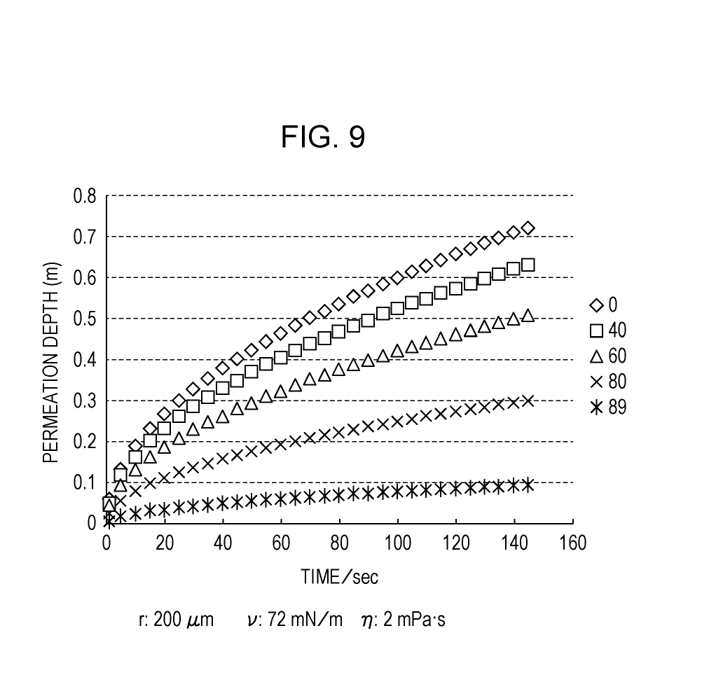

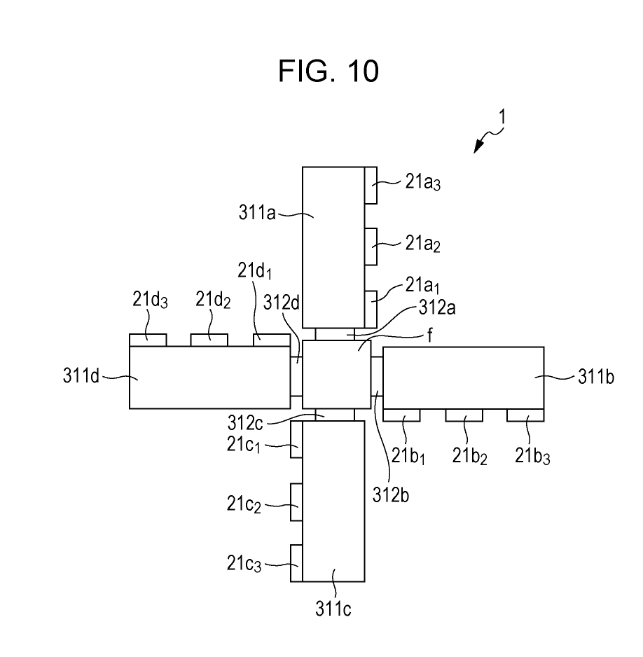

Since the water repellencies of the first fuel diffusing portions 311a, 311b, 311c, and 311d are made different from each other, the contact angles of a fuel F to the first fuel diffusing portions 311a, 311b, 311c, and 311d are changed from each other. When the contact angle is changed, the diffusion rate of the fuel F is changed, for example, as a graph used instead of drawing shown in FIG. 9 based on the following equation (1) (Lucas-Washburn equation). FIG. 9 is a graph used instead of drawing showing permeation rates at contact angles of 0°, 40°, 60°, 80°, and 89° when the capillary radius of the fuel diffusing portion is 200 μm, the surface tension of a fuel is 72 mN/m, and the viscosity thereof is 2 mPa·s. When the permeation rate is changed between the first fuel diffusing portion 311a, 311b, 311c, and 311d, the timing of power generation between the electromotive portions (in the figure, only the negative electrodes 21a, 21b, 21c, and 21d are shown) can be shifted

$$l = \sqrt{\frac{r γ cos θ}{2 η}} t \qquad [ Equation 1 ]$$

l: Permeation depth, r: Capillary radius of fuel diffusion portion, γ: Surface tension of fuel, θ: Contact angle, η: Viscosity of fuel, t: Time

As in this sixth embodiment, when the water repellencies of the first fuel diffusing portions 311a, 311b, 311c, and 311d are freely adjusted, the timing of power generation between the electromotive portions (in the figure, only the negative electrodes 21a, 21b, 21c, and 21d are shown) can be freely adjusted.

Although the water repellencies of the first fuel diffusing portions 311a, 311b, 311c, and 311d are made different from each other in the sixth embodiment, the method is not limited thereto, and when the water repellencies of the second fuel diffusing portions 312a, 312b, 312c, and 312d are made different from each other, the timing of power generation between the electromotive portions (in the figure, only the negative electrodes 21a, 21b, 21c, and 21d are shown) can also be freely adjusted.

In the methods described above in which the timing of power generation is adjusted, although the fuel diffusing portions are formed from the same material, and the modes (the shape, the water repellency, and the like) are made different between the fuel diffusing portions, the method is not limited thereto. For example, although not being shown in the figure, when materials forming the fuel diffusing portions are made different therebetween, that is, for example, when the first fuel diffusing portion 311a is formed from cupra, and the first fuel diffusing portion 311b is formed from a flow path, the fuel diffusion times from the fuel injection portion f to the negative electrodes 21a, 21b, 21c, and 21d can be adjusted.

As described above, although the power supply device 1 according to the embodiment of the present disclosure can be designed so as to shift the timing of power generation between the electromotive portions connected in series, for example, as is a seventh embodiment shown in FIG. 10, the structure may be designed in such a way that at least two electromotive portions (in the figure, only the negative electrodes 21a, 21b, 21c, and 21d are shown) are connected in parallel to the first fuel diffusing portions 311a, 311b, 311c, and 311d so as to shift the timing of power generation between the electromotive portions.

In more particular, as in the seventh embodiment shown in FIG. 10, when at least two electromotive portions (in the figure, only the negative electrodes 21a, 21b, 21c, and 21d are shown) are connected in parallel to the fuel diffusing portions 311a, 311b, 311c, and 311d, the distances from the fuel injection portion f to the negative electrodes 21a₁, 21a₂, and 21a₃ are made different from each other, and the distances from the fuel injection portion f to the negative electrodes 21b₁, 21b₂, and 21b₃, to the negative electrodes 21c₁, 21c₂, and 21c₃, and to the negative electrodes 21d₁, 21d₂, and 21d₃ are the same situation as that described above. Since the distances from the fuel injection portion f to the negative electrodes 21a₁, 21a₂, and 21a₃ are made different from each other as described above, the fuel diffusion times from the fuel injection portion f to the negative electrodes 21a₁, 21a₂, and 21a₃ are also made different from each other, and the fuel diffusion times from the fuel injection portion f to the negative electrodes 21b₁, 21b₂, and 21b₃, to the negative electrodes 21c₁, 21c₂, and 21c₃, and to the negative electrodes 21d₁, 21d₂, and 21d₃ are also the same situation as that described above. Hence, as a result, the timing of power generation can be shifted between the electromotive portions (in the figure, only the negative electrodes 21a₁ to 21a₃, 21b₁ to 21b₃, 21c₁ to 21c₃, and 21d₁ to 21d₃ are shown).

In addition, in the seventh embodiment, although three electromotive portions are provided for each of the first fuel diffusing portions 311a, 311b, 311c, and 311d (in the figure, only the negative electrodes 21a₁ to 21a₃, 21b₁ to 21b₃, 21c₁ to 21c₃, and 21d₁ to 21d₃ are shown), the structure is not limited thereto. For example, in accordance with the purpose, a plurality of electromotive portions may also be provided only to at least one of the fuel diffusing portions.

In addition, the power supply device 1 according to the embodiment of the present disclosure may also be designed in such a way that the timing of power generation is shifted between the electromotive portions connected in series, and the timing of power generation is further shifted between the electromotive portions connected in parallel.

As described from the fifth embodiment to the seventh embodiment, when the timing of power generation is adjusted between the electromotive portions, the following effects may be imparted to electronic apparatuses to be used.

For example, when the power supply device as described above is used for an instrument which generates music, effects of increasing sound volume with time, changing a single tone to a chord, and/or using an electronic music box with a time difference may be imparted.

In addition, for example, when the power supply device as described above is used for an apparatus which emits light, without using a special circuit and the like, a light source, such as an LED, can be made to emit light with a time difference.

In addition, for example, when the power supply device as described above is used for an apparatus driven by an electric power, without using special wires and the like, a driving portion can be freely changed.

The type of fuel to be supplied in the power supply device 1 according to the embodiment of the present disclosure described above is not particularly limited, and any common fuels used for fuel cells may be supplied.

For example, proteins, fatty acids, sugars, or other compounds can be used. Among those mentioned above, in particular, sugars are more preferable in views of ease availability thereof from food, its residue, fermentation products, or biomass, price, versatility, safety, easy handling, and the like.

In addition, fuels which can be drunk or eaten by a human being and which can be in contact therewith may also be used. For example, drinks, such as juices, sport drinks, sugar water, and alcohols, and cosmetics, such as face lotion, may be used. That is, drinks taken in everyday life, cosmetics, and the like may be used as a fuel for the power supply device 1 according to the embodiment of the present disclosure. When a fuel which can be drunk or eaten by a human being or which can be in contact therewith is used, besides safety, merit in that any type of fuel may be supplied at any place is also obtained.

<2. Electronic Apparatus>

Since the power supply device 1 according to the embodiment of the present disclosure can obtain high output current and voltage and can also simultaneously and equally supply a fuel to negative electrodes, and in addition, since any particular operation is not necessary from fuel supply to power generation, stable power generation can be performed within a short time. Therefore, the power supply device 1 according to the embodiment of the present disclosure can be preferably used for any common electronic apparatuses.

The above electronic apparatuses include all types of apparatuses which are electrically operated as long as being able to use at least the power supply device according to the embodiment of the present disclosure, and the structure, the functions, and the like of the apparatuses are not particularly limited. For example, there may be mentioned electronic apparatuses, such as a cellular phone, a mobile apparatus, a robot, a personal computer, a game machine, an in-vehicle apparatus, a home electric appliance, and an industrial product; moving vehicles, such as a car, a two-wheeled vehicle, an airplane, a rocket, and a spacecraft; inspection apparatuses; medical apparatuses, such as a power supply for a pacemaker and a power source for an in-vivo device including a biosensor; and a power generation system and a cogeneration system, such as a system for decomposing kitchen garbage and generating electric energy.

The present disclosure can also have the following structures.

(1) A power supply device in which an enzyme is immobilized as a catalyst on negative electrodes and/or positive electrodes, includes electromotive portions in which at least two of the negative electrodes and the positive electrodes are connected in series; and a fuel supply portion which communicates with the negative electrodes and which simultaneously supply a fuel to the negative electrodes, and in the power supply device, the fuel supply portion includes fuel-supply adjusting portions which adjust fuel supply to the negative electrodes.

(2) In the power supply device of the above (1), the fuel-supply adjusting portions include first fuel diffusing portions in contact with the negative electrodes and second fuel diffusing portions which are in contact with the first fuel diffusing portions and which have a low fuel diffusion rate as compared to that of the first fuel diffusing portions.

(3) In the power supply device of the above (2), the first fuel diffusing portions each include at least one of paper, cloth, a flow path, a polymer, and a hydrophilic coating material.

(4) In the power supply device of the above (2) or (3), the second fuel diffusing portions each include at least one of paper, cloth, a flow path, a polymer, a hydrophilic coating material, and a hydrophobic coating material.

(5) In the power supply device of one of the above (2) to (4), modes of the first fuel diffusing portions and/or the second fuel diffusing portions are made different from each other so that fuel diffusion times from a fuel injection portion to the negative electrodes are different from each other.

(6) In the power supply device of the above (5), the shapes of the first fuel diffusing portions and/or the second fuel diffusing portions are made different from each other so that the distances from the fuel injection portion to the negative electrodes are different from each other.

(7) The power supply device of the above (5) or (6), water repellencies of the first fuel diffusing portions and/or the second fuel diffusing portions are made different from each other.

(8) In the power supply device of one of the above (2) to (7), the negative electrodes and the positive electrodes are connected in parallel to at least one of the first fuel diffusing portions so that the distances from a fuel injection portion to the negative electrodes are different from each other.

(9) In the power supply device of one of the above (1) to (8), an ion isolation portion ionically isolating between the negative electrodes is further included.

(10) In the power supply device of one of the above (1) to (9), the enzyme immobilized on the negative electrodes at least contains an oxidase.

(11) In the power supply device of one of the above (1) to (10), the enzyme immobilized on the negative electrodes at least contains an oxidized coenzyme.

(12) In the power supply device of the above (11), the enzyme immobilized on the negative electrodes at least contains a coenzyme oxidase.

(13) In the power supply device of one of the above (1) to (12), an electron transfer mediator is immobilized on the negative electrodes and/or the positive electrodes.

(14) An electronic apparatus using fuel cells in which an oxidoreductase is immobilized as a catalyst on negative electrodes and/or positive electrodes, includes a fuel cell portion in which at least two fuel cells are connected in series; and a fuel supply portion which communicates with the negative electrodes of the fuel cells and which simultaneously supplies a fuel to the negative electrodes, and the fuel supply portion includes fuel-supply adjusting portions which adjust fuel supply to the negative electrodes.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A power supply device in which an enzyme is immobilized as a catalyst on negative electrodes and/or positive electrodes, comprising:
electromotive portions in which at least two of the negative electrodes and the positive electrodes are connected in series; and
a fuel supply portion which communicates with the negative electrodes and which simultaneously supply a fuel to the negative electrodes,
wherein the fuel supply portion includes fuel-supply adjusting portions which adjust fuel supply to the negative electrodes.

2. The power supply device according to claim 1,
wherein the fuel-supply adjusting portions include first fuel diffusing portions in contact with the negative electrodes and second fuel diffusing portions which are in contact with the first fuel diffusing portions and which have a low fuel diffusion rate as compared to that of the first fuel diffusing portions.

3. The power supply device according to claim 2,
wherein the first fuel diffusing portions each include at least one of paper, cloth, a flow path, a polymer, and a hydrophilic coating material.

4. The power supply device according to claim 2,
wherein the second fuel diffusing portions each include at least one of paper, cloth, a flow path, a polymer, a hydrophilic coating material, and a hydrophobic coating material.

5. The power supply device according to claim 2,
wherein modes of the first fuel diffusing portions and/or the second fuel diffusing portions are different from each other, so that fuel diffusion times from a fuel injection portion to the negative electrodes are different from each other.

6. The power supply device according to claim 5,
wherein the shapes of the first fuel diffusing portions and/or the second fuel diffusing portions are different from each other, so that the distances from the fuel injection portion to the negative electrodes are different from each other.

7. The power supply device according to claim 5,
wherein the first fuel diffusing portions and/or the second fuel diffusing portions have different water repellencies from each other.

8. The power supply device according to claim 2,
wherein the negative electrodes and the positive electrodes are connected in parallel to at least one of the first fuel diffusion portions, so that the distances from a fuel injection portion to the negative electrodes are different from each other.

9. The power supply device according to claim 1, further comprising an ion isolation portion which ionically isolates between the negative electrodes.

10. The power supply device according to claim 1,
wherein the enzyme immobilized on the negative electrodes includes an oxidase.

11. The power supply device according to claim 1,
wherein the enzyme immobilized on the negative electrodes includes an oxidized coenzyme.

12. The power supply device according to claim 11,
wherein the enzyme immobilized on the negative electrodes includes a coenzyme oxidase.

13. The power supply device according to claim 1, further comprising an electron transfer mediator immobilized on the negative electrodes and/or the positive electrodes.

14. An electronic apparatus using fuel cells in which an oxidoreductase is immobilized as a catalyst on negative electrodes and/or positive electrodes, comprising:
a fuel cell portion in which at least two fuel cells are connected in series; and
a fuel supply portion which communicates with the negative electrodes of the fuel cells and which simultaneously supplies a fuel to the negative electrodes,
wherein the fuel supply portion includes fuel-supply adjusting portions which adjust fuel supply to the negative electrodes.
